(19) United States
(12) Patent Application Publication
(10) Pub. No.: US 2019/0172603 A1
(43) Pub. Date: Jun. 6, 2019

(54) METHOD FOR MANUFACTURING SILVER-COATED COPPER NANOWIRE HAVING CORE-SHELL STRUCTURE BY USING CHEMICAL REDUCTION METHOD

(71) Applicant: BIONEER CORPORATION, Daejeon (KR)

(72) Inventors: Han Oh Park, Daejeon (KR); Jae Ha Kim, Daejeon (KR); Jun Pyo Kim, Daejeon (KR); Kug Jin Yun, Daejeon (KR)

(21) Appl. No.: 16/306,570

(22) PCT Filed: May 30, 2017
(86) PCT No.: PCT/KR2017/005600

§ 371 Date: Dec. 1, 2018

(30) Foreign Application Priority Data
Jun. 3, 2016 (KR) 10-2016-0069400

(51) Int. Cl. H01B 1/02; B22F 1/00; B22F 1/02; B22F 9/24

(52) U.S. Cl. CPC H01B 1/02; B22F 9/24; B22F 1/025; B22F 1/0025

(57) ABSTRACT

The present invention relates to silver-coated copper nanowires having a core-shell structure using chemical reduction and a method of preparing the same. More particularly, the present invention relates to a method of preparing silver-coated copper nanowires including chemically producing copper nanowires and coating the surface of the copper with silver using a silver-ammonia complex solution and a reducing agent in order to prevent oxidation of the copper nanowires by chemical reduction, and silver-coated copper nanowires having a core-shell structure produced by the method. In addition, production costs can be reduced because copper nanowires can be produced by reusing solutions.

The method of preparing silver-coated copper nanowires having a core-shell structure according to the present invention can avoid deterioration in electrical conductivity by preventing oxidation even in the air or at high temperatures, thus being useful for the production of electromagnetic shielding paste or highly conductive paste requiring high electrical conductivity.

### TECHNICAL FIELD

The present invention relates to a method of preparing silver-coated copper nanowires having a core-shell structure using chemical reduction, and more particularly, to a method of preparing silver-coated copper nanowires including chemically producing copper nanowires and coating the surface of the copper with silver using a silver-ammonia complex solution and a reducing agent in order to prevent oxidation of the copper nanowires by chemical reduction.

### BACKGROUND ART

Nanowires are nanomaterials that have a diameter of several nanometers and a length of several hundred nanometers to several hundred micrometers, which attract a great deal of attention as core materials used in the production of next-generation nano-devices due to easy artificial operation. Recently, metal nanowires such as copper, silver and nickel nanowires are usefully utilized as alternatives to replace indium tin oxide (ITO), conductive polymers, carbon-nanotubes, graphene, etc., due to properties such as conductivity and transparency.

Among them, copper nanowires arise as a substitute for indium tin oxide (ITO), which has been mainly used for displays, because of advantages such as high conductivity, flexibility, transparency and low price. In particular, copper nanowires can be used in a wide variety of applications including low emissivity windows, touch-sensitive control panels, solar cells and electromagnetic shielding materials, because they are transparent conductors.

Conventionally, copper nanowires have been produced by methods such as electrochemical reaction, chemical vapor deposition, hard-template assisted methods, and colloidal and hydrothermal processes. However, conventional manufacturing methods have problems such as high equipment investment costs, difficulty in controlling the size of nanowires and low productivity.

Recently, methods for manufacturing copper nanowires by chemical synthesis have been known. Korean Patent No. 10-73808 discloses a method of preparing copper nanowires including mixing an amine ligand, a reducing agent, a surfactant and a non-polar organic solvent with an aqueous solution of CuCl₂, transferring the reaction solution to a high-pressure reactor and proceeding reaction at 80 to 200° C. for 24 hours. The copper nanowires produced by this method have a length of 10 to 50 μm and a diameter of 200 to 1,000 nm. However, this production method is conducted using a high-pressure reactor, which may cause problems of increased production costs and inapplicability to mass production.

Korean Patent No. 1334601 discloses a method of preparing copper nanowires by a polyol process using ethylene glycol (EG) and polyvinyl pyrrolidone (PVP). However, such a production method causes environmental problems in that a toxic solvent is used as compared with the case where an aqueous solution is used as a solvent, and has a problem of deteriorated economic efficiency due to an increased production cost.

International Patent Publication No. 2011-071885 discloses a method of manufacturing copper nanowires having a length of 1 to 500 μm and a diameter of about 20 to 300 nm by mixing a copper ion precursor, a reducing agent, a capping agent, and a pH adjuster, followed by reaction at a predetermined temperature to obtain copper nanowires including a copper stick attached to spherical copper nanoparticles. However, this method still has drawbacks such as low productivity and low quality uniformity of produced copper nanowires.

On the other hand, when copper nanowires are exposed to the air for a long time, oxidation occurs to form copper oxide. This oxidation phenomenon progresses more rapidly as the temperature increases. Such a copper oxide is significantly less electrically conductive than pure copper. In order to prevent production of such copper oxide, International Patent Publication No. 2011-071885 and Korean Patent Laid-open No. 1334601 disclose producing copper nanowires and surface-treating the copper nanowires with a metal such as nickel, gold, tin, zinc, silver, platinum, titanium, aluminum, tungsten, cobalt or the like. However, there is still a need to improve overall process efficiency and quality uniformity of copper nanowires.

Accordingly, as a result of intensive efforts to solve the above problems, the present inventors developed a method for coating the surfaces of chemically synthesized copper nanowires with silver by chemical reduction using a silver-ammonia complex solution and a reducing agent in order to prevent oxidation and found that the method enables production of silver-coated copper nanowires having high economic efficiency and productivity, as well as high resistance to oxidation, as compared with conventional methods for producing copper nanowires, thus completing the present invention.

### SUMMARY OF THE INVENTION

Therefore, the present invention has been made in view of the above problems, and it is an object of the present invention to provide a method of preparing silver-coated copper nanowires having high economic efficiency and productivity, as well as high resistance to oxidation.

To accomplish the above object, the present invention provides a method of preparing silver-coated copper nanowires having a core-shell structure comprising: (a) stirring an aqueous solution containing (1) an alkali, (2) a copper compound and (3) a capping agent in water; (b) producing copper nanowires by adding a reducing agent to the aqueous solution to reduce copper ions; (c) washing and drying produced copper nanowires; (d) removing an oxide film from the copper nanowires produced in step (c); (e) adding a reducing agent to the solution of step (d), adjusting pH and then forming a silver coating while adding a silver nitrate-ammonia complex solution dropwise; and (f) washing and drying silver-coated copper nanowires prepared in step (e).

### BRIEF DESCRIPTION OF THE DRAWINGS

FIG. 1 is a scanning electron microscopy (SEM) image of copper nanowires produced in Example 1.

FIG. 2 is a scanning electron microscope (SEM-EDS) image showing results of content analysis of copper nanowires produced in Example 1.

FIG. 3 is a scanning electron microscopy (SEM) image of copper nanowires produced in Example 2.

FIG. 4 is a scanning electron microscopy-energy dispersive spectroscopy (SEM-EDS) image showing results of content analysis of copper nanowires produced in Example 2.

FIG. 5 is a scanning electron microscopy (SEM) image of silver-coated copper nanowires produced using Cu(OH)₂ as a copper precursor.

FIG. 6 is a scanning electron microscopy (SEM) image of copper nanowires synthesized by reusing a NaOH solution once in Example 4.

FIG. 7 is a scanning electron microscopy (SEM) image of copper nanowires synthesized by reusing a NaOH solution twice in Example 4.

FIG. 8 is a scanning electron microscopy (SEM) image of copper nanowires synthesized by reusing a NaOH solution once in Example 5.

FIG. 9 is a scanning electron microscopy (SEM) image of copper nanowires synthesized by reusing a NaOH solution twice in Example 5.

FIG. 10 is a scanning electron microscopy (SEM) image of silver-coated copper nanowires with a core-shell structure produced in Example 6.

FIG. 11 is a scanning electron microscopy-energy dispersive spectroscopy (SEM-EDS) image showing results of content analysis of silver-coated copper nanowires with a core-shell structure produced in Example 6.

FIG. 12 is an ion beam scanning electron microscopy (FIB) image showing the thickness of a silver coating of the silver-coated copper nanowires with a core-shell structure produced in Example 6.

FIG. 13 is a scanning electron microscopy (SEM) image of silver-coated copper nanowires with a core-shell structure produced in Comparative Example 1.

FIG. 14 is a scanning electron microscopy-energy dispersive spectroscopy (SEM-EDS) image showing results of content analysis of silver-coated copper nanowires with a core-shell structure produced in Comparative Example 1.

FIG. 15 is a scanning electron microscopy (SEM) image of silver-coated copper nanowires with a core-shell structure produced in Comparative Example 2.

FIG. 16 is a scanning electron microscopy-energy dispersive spectroscopy (SEM-EDS) image showing results of content analysis of silver-coated copper nanowires with a core-shell structure produced in Comparative Example 2.

FIG. 17 is a scanning electron microscopy (SEM) image of silver-coated copper nanowires with a core-shell structure produced in Example 7.

FIG. 18 is a scanning electron microscopy-energy dispersive spectroscopy (SEM-EDS) image showing results of content analysis of silver-coated copper nanowires with a core-shell structure produced in Example 7.

FIG. 19 is an ion beam scanning electron microscopy (FIB) image showing the thickness of a silver coating of the silver-coated copper nanowires with a core-shell structure produced in Example 7.

FIG. 20 is a scanning electron microscopy (SEM) image of silver-coated copper nanowires with a core-shell structure produced in Example 8.

FIG. 21 is a scanning electron microscopy-energy dispersive spectroscopy (SEM-EDS) image showing results of content analysis of silver-coated copper nanowires with a core-shell structure produced in Example 8.

FIG. 22 is an ion beam scanning electron microscope (FIB) image showing the thickness of a silver coating of the silver-coated copper nanowires with a core-shell structure produced in Example 8.

FIG. 23 is a scanning electron microscopy (SEM) image of silver-coated copper nanowires with a core-shell structure produced in Example 9.

FIG. 24 is a scanning electron microscopy-energy dispersive spectroscopy (SEM-EDS) image showing results of content analysis of silver-coated copper nanowires with a core-shell structure produced in Example 9.

FIG. 25 is an ion beam scanning electron microscope (FIB) image showing the thickness of a silver coating of the silver-coated copper nanowires with a core-shell structure produced in Example 9.

FIG. 26 is a scanning electron microscopy (SEM) image of silver-coated copper nanowires with a core-shell structure produced in Example 10.

FIG. 27 is a scanning electron microscopy-energy dispersive spectroscopy (SEM-EDS) image showing results of content analysis of silver-coated copper nanowires with a core-shell structure produced in Example 10.

FIG. 28 is a scanning electron microscopy (SEM) image of silver-coated copper nanowires with a core-shell structure produced in Example 11.

FIG. 29 is a scanning electron microscopy-energy dispersive spectroscopy (SEM-EDS) image showing results of content analysis of silver-coated copper nanowires with a core-shell structure produced in Example 11.

FIG. 30 is a scanning electron microscopy (SEM) image of silver-coated copper nanowires with a core-shell structure produced in Example 12.

FIG. 31 is a scanning electron microscopy-energy dispersive spectroscopy (SEM-EDS) image showing results of content analysis of silver-coated copper nanowires with a core-shell structure produced in Example 12.

FIG. 32 is an image showing results of spectrum profile scanning on silver-coated copper nanowires with a core-shell structure produced in Example 6 with an energy dispersive spectroscope mounted on a transmission electron microscope (TEM) in Experimental Example 2.

### BEST MODE FOR CARRYING OUT THE INVENTION

Unless defined otherwise, all technical and scientific terms used herein have the same meaning as those appreciated by those skilled in the field to which the present invention pertains. In general, nomenclature used herein is well-known in the art and is ordinarily used.

In the present invention, copper nanowires are prepared using piperazine and/or hexamethylenediamine as a capping agent, the oxide film of the copper nanowires is removed and the copper nanowires are then coated with silver by a chemical method to produce core-shell type silver-coated copper nanowires. As a result, it can be found that the silver-coated copper nanowires having a core-shell structure have better oxidation stability than conventional copper nanowires and can be produced at a lower cost than silver nanowires having similar physical properties.

Accordingly, the present invention relates to a method of preparing silver-coated copper nanowires: including (a) stirring an aqueous solution containing (1) an alkali, (2) a copper compound and (3) a capping agent in water; (b) reducing copper ions by adding a reducing agent to the aqueous solution to produce copper nanowires; (c) washing and drying the produced copper nanowires; (d) removing an oxide film from the copper nanowires produced in step (c); (e) adding a reducing agent to the solution of step (d), adjusting pH, and forming a silver coating while adding a silver nitrate-ammonia complex solution dropwise; and (f) washing and drying the silver-coated copper nanowires prepared in step (e).

In the present invention, the method may further include (c′) re-synthesizing the copper nanowires by adding a copper precursor and a reducing agent to the solution separated from the copper nanowires, after step (c). Even after the copper nanowires are synthesized, a considerable amount of copper precursor and reducing agent remain in the solution separated from the copper nanowires. In addition, since the alkali solution used for the reaction should be supplied at a high concentration, the costs of purchasing and disposing of a new alkali solution are required when the alkali solution is discarded without treatment. Therefore, when the copper precursor and the reducing agent are additionally supplied to the separated solution to perform reaction, production costs can be significantly reduced. In addition, production costs are preferably minimized by synthesizing copper nanowires by repeating step (c) two or more times.

In step (d) of the present invention, a mixed solution of ammonia water and ammonium sulfate may be used as a solution for removing the oxide film. Copper nanowires are oxidized after they are produced, thus forming an oxide film (copper oxide) on the surface thereof. This oxide film may lower the conductivity of copper nanowires and may interfere with contact with silver coated on the surface. Therefore, it is preferable to remove the oxide film before silver coating. At this time, the concentration of the mixed solution of ammonia water and ammonium sulfate is more preferably 0.001 to 0.3M. When the concentration of the mixed solution of ammonia water and the ammonium sulfate is less than 0.001M, the oxide film may not be removed properly and thus the silver coating layer may not be formed or the conductivity of the copper nanowires may be lowered. When the concentration is higher than 0.3M, copper nanowires may be decomposed and thus the overall yield may be reduced due to high consumption of copper. In addition, the solution may be a substance containing an amine, instead of a solution containing ammonia ions. The solution may further include other amine-based substances or additives, but the present invention is not limited thereto. In addition, step (d) for removing the oxide film is preferably performed for 1 to 60 minutes. When the reaction time is less than 1 minute, the oxide film may not be removed and, when the reaction time is longer than 60 minutes, copper nanowires may be dissolved.

In the present invention, in step (e), the reducing agent is added to the copper nanowire solution from which the oxide film has been removed in step (d), the pH is adjusted and a silver-ammonia complex solution is fed at a rate of 0.5 to 500 ml/min, while stirring at 50 to 1,600 rpm. Step e) serves to form a silver coating on the copper nanowire from which the oxide film has been removed in step (d). When the silver-ammonia complex solution is fed at a rate of less than 0.5 ml/min, the amount of silver to be reduced is small and a dense silver coating layer is thus formed. When the silver-ammonia complex solution is fed at a rate of higher than 500 ml/min, silver may not be coated on the copper nanowires and free silver particles may be formed in the solution.

In addition, when the stirring rate of the solution is less than 50 rpm, the diffusion rate of the silver-ammonia complex is reduced and the silver coating is not sufficiently formed on the surface of the copper nanowires. When the stirring rate is higher than 1,600 rpm, the flowability of the solution may become unstable and thus the reactivity may be lowered.

In the present invention, the pH of the solution in which the copper nanowires are dispersed may be 8 to 11. When the pH is less than 8, the silver coating may not be formed properly on the copper nanowires. When the pH is higher than 11, copper may be dissolved and the yield may be reduced. At this time, the reagent for adjusting pH is at least one selected from NaOH, KOH, ammonia water and the like. Preferably, the pH is adjusted with ammonia water, but the present invention is not limited thereto. The concentration of the ammonia water may be 0.001 to 0.1M in the solution in which the copper wires are dispersed, but the present invention is not limited thereto. When the concentration of ammonia water is less than 0.001M, silver coating may not be properly performed on the surface of the copper nanowires. When the concentration is higher than 0.1M, the copper nanowires may be dissolved and the yield may be deteriorated.

In the present invention, the reducing agent in step (e) may be selected from the group consisting of oxalic acid, malonic acid, succinic acid, glutaric acid, adipic acid, pimelic acid, suberic acid, azelaic acid, sebacic acid, brassylic acid, dodecanoic acid, thapsic acid, maleic acid, fumaric acid, gluconic acid, traumatic acid, muconic acid, glutinic acid, citraconic acid, mesaconic acid, aspartic acid, glutamic acid, diaminopimelic acid, tartronic acid, arabinaric acid, saccharic acid, mesoxalic acid, oxaloacetic acid, acetonedicarboxylic acid, phthalic acid, isophthalic acid, terephthalic acid, diphenic acid, tartaric acid, sodium potassium tartrate, ascorbic acid, hydroquinone, glucose, hydrazine and the like. Any reducing agent may be used as the reducing agent in step (e) without limitation so long as it can reduce silver to conduct silver coating. However, a weak reducing agent is used so that a silver coating can be formed uniformly and is preferably sodium potassium tartrate.

In the present invention, the concentration of the reducing agent in step (e) may be 0.001 to 3M. When the concentration of the reducing agent is less than 0.001M, reduction reaction is deteriorated and the silver coating layer is thus not formed. When the concentration of the reducing agent is higher than 3M, economic and environmental loss is large due to great reagent consumption.

In the present invention, the silver-ammonia complex solution is prepared by mixing a silver nitrate solution with ammonia water. The principle that a silver coating layer is formed on copper nanowires is based on chemical plating. In order to coat copper nanowires with silver, a silver-ammonia complex solution should be coated, and ammonia water may be added to the silver nitrate solution.

Specifically, a silver-ammonia complex solution is produced by adding ammonia water to a silver nitrate solution. The scheme for this reaction can be depicted by Reaction Scheme 2. [Ag(NH₃)₂]⁺, which is a silver-ammonia complex, is formed in accordance with 3) in Reaction Scheme 2.

[Reaction Scheme 2]

2AgNO₃+2NH₄OH→Ag₂O↓+H₂O+2NH₄NO₃ 1)

Ag₂O+4NH₄OH→2[Ag(NH₃)₂]OH+3H₂O 2)

[Ag(NH₃)₂]OH+NH₄NO₃→[Ag(NH₃)₂]NO₃+NH₄OH 3)

The copper nanowires are coated with silver atoms through the chemical plating principle in which the Ag ion of the complex of [Ag(NH₃)₂]⁺ formed in 3) of Reaction Scheme 2 is reduced by an electron derived from copper nanowires. This reaction is depicted by the following Reaction Scheme 3.

Cu+2[Ag(NH₃)₂]NO₃→[Cu(NH₃)₄](NO₃)₂+2Ag↓ [Reaction Scheme 3]

In the present invention, the concentration of silver nitrate in the silver-ammonia complex solution may be 0.001 to 1M and the concentration of ammonia water may be 0.01 to 0.3M. When the concentration of silver nitrate is less than 0.001M or higher than 1M, or when the concentration of ammonia water is less than 0.01M or higher than 0.3M, it is difficult to form the complex.

In the present invention, the alkali in step (a) may be NaOH, KOH or Ca(OH)₂. It is preferable that the concentration of the alkali solution in step (a) is in the range of 2.5 to 25M. When the concentration of the alkali solution is less than 2.5M, the solution does not maintain the pH and thus the reduction reaction of the copper ions does not occur properly. When the concentration of the alkali solution is higher than 25M, the alkali reacts with copper and thus the nanowires are not formed as desired.

In the present invention, the copper compound may be copper hydroxide, copper nitrate, copper sulfate, copper sulfite, copper acetate, copper chloride, copper bromide, copper iodide, copper phosphate or copper carbonate, preferably, copper nitrate. The copper compound provides copper ions necessary for growth of copper nanowires. In the present invention, the copper compound may have a concentration of 0.004 to 0.5M based on copper ions. When the concentration of the copper ions is less than 0.004M, copper nanowires may not be properly formed and copper nanoparticles may be formed. When the concentration of the copper ions is higher than 0.5M, the reaction with the reducing agent does not occur completely as copper ions are excessively present in the solution.

In the present invention, the capping agent (3) may be piperazine (C₄H₁₀N₂) or hexamethylenediamine (C₆H₁₆N₂). In order to produce the copper ions contained in the copper compound into nanowires, the shape of the copper nanowires should be controlled by the amine groups contained in the capping agent. The capping agent binds to the copper nanostructure and the copper grows in a longitudinal direction, so that nanowire morphology can be obtained. The copper capping agent used herein is preferably piperazine (C₄H₁₀N₂) and/or hexamethylenediamine (C₆H₁₆N₂). Piperazine (C₄H₁₀N₂) and hexamethylenediamine (C₆H₁₆N₂) may be represented by the following Formula 1 and Formula 2, respectively:

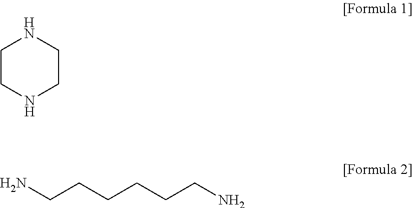 [SMILES: C1CNCCN1 ; NCCCCCCN]

In the present invention, the concentration of \textcircled{3} the capping agent may be 0.008 to 2.0M. When the concentration of the capping agent is less than 0.008M, copper discs as well as copper nanowires may be formed, and when the concentration of the capping agent is higher than 2.0M, disc-shaped coppers may be formed.

In the present invention, the stirring in step (a) is carried out so as to ensure that all of the materials added to the aqueous solution are well dissolved and may be carried out using a conventional stirrer, but the present invention is not limited thereto. The stirring rate is preferably 200 to 400 rpm and the stirring time is preferably 5 to 30 minutes. However, the stirring rate and time are freely selectable in consideration of the amount of the aqueous solution, the reaction time and the like.

In the present invention, the reducing agent in step (b) may be hydrazine, ascorbic acid, L(+)-ascorbic acid, isoascorbic acid, ascorbic acid derivatives, oxalic acid, formic acid, phosphite, phosphoric acid, sulfite or sodium borohydride, preferably hydrazine.

The process wherein hydrazine reduces copper ions to copper in the presence of an alkali solution is depicted by the following Reaction Scheme 1:

2Cu²⁺+N₂H₄+4OH⁻2Cu+N₂+4H₂O [Reaction Scheme 1]

In the present invention, the concentration of the reducing agent in step (b) may be 0.01 to 1.0M and the rate of reducing agent added may be 0.1 to 500 ml/min. When the reducing agent concentration is less than 0.01M or higher than 1.0M, or when the addition rate of the reducing agent is less than 0.1 ml/min or higher than 500 ml/min, copper nanoparticles may be formed instead of copper nanowires. In step (b), after addition of the reducing agent, the copper ions are reduced by stirring for 30 minutes to 2 hours, preferably 1 hour. When the reaction time is less than 30 minutes, the thickness and length of copper nanowires are not suitable. When the reaction time is higher than 2 hours, remaining copper ions are reduced on the surface of the copper nanowires, which may cause the wires to have uneven surfaces.

Also, step (b) may be performed at 0 to 100° C. When the reaction temperature during the reduction is less than 0° C. or higher than 100° C., copper reduction reaction occurs, but copper nanoparticles may be formed instead of nanowires.

In the present invention, in step (c), the produced copper nanowires are washed and dried. In step (c), impurities are removed from the surfaces of the copper nanowires and the copper nanowires are dried. During synthesis of the copper nanowires, the copper nanowires may be washed and dried using a material for removing impurities on the surface, preferably, distilled water and an ethanol solution. During washing of the copper nanowires, the impurities on the surface of the copper nanowires are washed several times with distilled water, washed once or twice with ethanol for rapid drying, and dried in a vacuum oven at room temperature for 12 to 30 hours, but the present invention is not limited thereto.

In the present invention, step (f) serves to wash and dry the silver-coated copper nanowires produced in step (e), and is performed by the same cleaning step as in step (c).

In the present invention, the method for manufacturing silver-coated copper nanowires with a core-shell structure can be carried out by batch reaction, plug flow reaction, or continuous stirring tank reaction, but the present invention is not limited thereto.

Hereinafter, the present invention will be described in more detail with reference to examples. However, it is obvious to those skilled in the art that these examples are provided only for illustration of the present invention and should not be construed as limiting the scope of the present invention.

### EXAMPLE

The specifications of the equipment used in the example and methods for measuring physical properties are as follows:

1) Measurement of morphology and structure: morphology and structure of silver-coated copper nanowires with a core-shell structure were measured with a scanning electron microscope (SEM; FEI, SIRION) and a transmission electron microscope (TEM; FEI, TECNAI G²-T-20S).

2) Measurement of ingredients: ingredients of silver-coated copper nanowires with a core-shell structure were measured with a scanning electron microscope-energy dispersive spectroscope (SEM-EDS; FEI, SIRION) and a transmission electron microscope-energy dispersive spectroscope (TEM-EDS; FEI, TECNAI G²-T-20S). In addition, the contents of silver and copper of silver-coated copper nanowires with a core-shell structure were analyzed by inductively coupled plasma-atomic emission spectroscopy (ICP-AES; iCAP 6500, Thermo Scientific).

3) Sheet resistance: sheet resistance was measured with a four-point sheet resistance meter (Loresta-GP, MCP-T610, MITSUBISHI CHEMICAL ANALYTECH).

4) Measurement of thickness: The thickness of silver-coated copper nanowires with a core-shell structure was measured with a focused ion-beam (FIB) scanning electron microscope (LYRA3 XMU, TESCAN).

5) Analysis of content: Content analysis of silver and copper of silver-coated copper nanowires with a core-shell structure were measured with an inductively coupled plasma-atomic emission spectrometer (ICP-AES, iCAP 6500 duo, Thermo Scientific).

### Example 1

### Production of Copper Nanowires Using Piperazine (C₄H₁₀N₂)

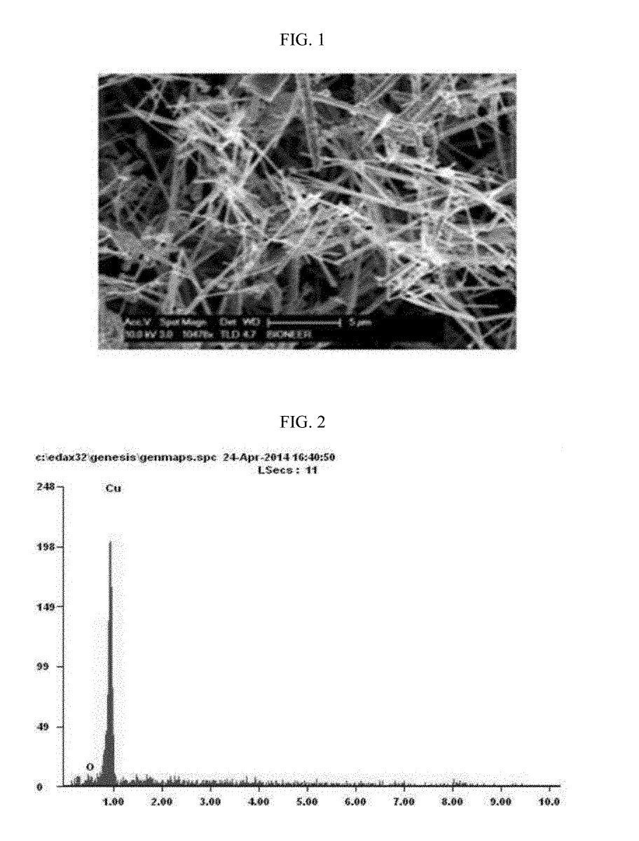

2,000 ml of water (ultrapure water) was fed into a 3,000 ml round flask, and 1,200 g (15M) of sodium hydroxide (NaOH, manufactured by Samchun Pure Chemical Co., Ltd.) was added while stirring with a stirrer. The reactor heated by exothermic reaction was cooled to an inner temperature of 50° C. or less, 3.8 g (0.0079M) of copper (II) nitrate (Cu(NO₃)₂.3H₂O, manufactured by Samchun Pure Chemical Co., Ltd.) was then dissolved in 100 ml of water (ultrapure water) and the resulting solution was fed into the reactor. Then, 9.7 g (0.268M) of piperazine (C₄H₁₀N₂, Sigma Aldrich Corporation) was dissolved in 100 ml of water (ultrapure water) and the resulting solution was fed into the reactor, followed by stirring at an average stirring rate of 300 rpm for 10 minutes. After the temperature of the reactor was elevated to 70° C., 4 ml of hydrazine (N₂H₄, Samchun Pure Chemical Co., Ltd.) was mixed with 240 ml (0.04M) of water (ultrapure water), and the resulting mixture was fed into the reactor using a syringe pump at a rate of 4 ml/min for one hour. After the reactor was maintained at 70° C., and the reaction was then completed, the reaction solution was slowly cooled to room temperature. Then, the copper nanowires were separated from the solution and then washed with distilled water and 2 L of ethanol. Then, the copper nanowires were dried in a vacuum oven (JEIO Tech, OV-12) at 25° C. for 24 hours. As a result of scanning electron microscopy (SEM) of the produced copper nanowires, as can be seen from FIG. 1, copper nanowires having a length of 5 to 10 μm and a diameter of 200 to 300 nm were produced. As can be seen from FIG. 2, results of analysis of the ingredients and contents of the copper nanowires with a scanning electron microscope-energy dispersive spectroscope (SEM-EDS) showed that unoxidized copper nanowires were produced.

### Example 2

### Production of Copper Nanowires Using Hexamethylenediamine (C₆H₁₆N₂)

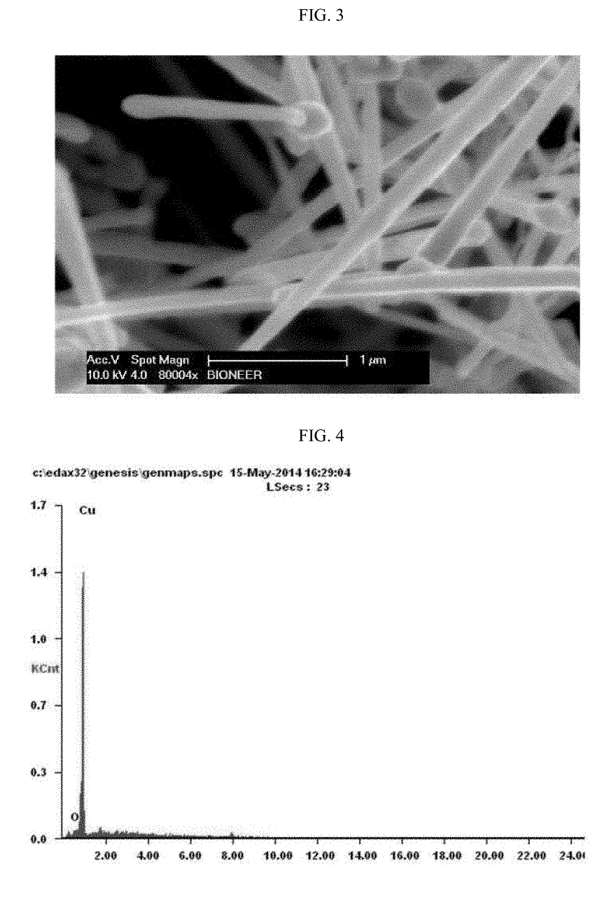

2,000 ml of water (ultrapure water) was fed into a 3,000 ml round flask, and 1,200 g of sodium hydroxide (NaOH, manufactured by Samchun Pure Chemical Co., Ltd.) was added while stirring with a stirrer. The reactor heated by exothermic reaction was cooled to an inner temperature of 50° C. or less, 3.8 g of copper (II) nitrate (Cu(NO₃)₂.3H₂O, manufactured by Samchun Pure Chemical Co., Ltd.) was then dissolved in 100 ml of water (ultrapure water) and the resulting solution was fed into the reactor. Then, 62.25 ml (0.268M) of hexamethylenediamine (C₆H₁₆N₂, Sigma Aldrich Corporation) was added thereto, followed by stirring at an average stirring rate of 300 rpm for 10 minutes. After the temperature of the reactor reached 35° C., 4 ml of hydrazine (N₂H₄, Samchun Pure Chemical Co., Ltd.) was mixed with 240 ml of water (ultrapure water), and the resulting mixture was fed into the reactor using a syringe pump at a rate of 4 ml/min for one hour. After the temperature of the reactor was elevated to 70° C., the reaction proceeded for one hour. After completion of reaction, the reaction solution was slowly cooled to room temperature. Then, the copper nanowires were washed with distilled water and 2 L of ethanol. Then, the copper nanowires were dried in a vacuum oven (JEIO Tech, OV-12) at 25° C. for 24 hours. As a result of scanning electron microscopy (SEM) of the produced copper nanowires, as can be seen from FIG. 3, copper nanowires having a length of 2 to 5 and a diameter of 200 to 300 nm were produced. As can be seen from FIG. 4, results of analysis of the ingredients and contents of the copper nanowires with a scanning electron microscope-energy dispersive spectroscope (SEM-EDS) showed that unoxidized copper nanowires were produced.

### Example 3

### Production of Copper Nanowires Using Copper Precursor Cu(OH)₂

Copper nanowires were produced in the same manner as in Example 1, except that copper hydroxide (Cu(OH)₂, Samchun Pure Chemical Co., Ltd.) was used as a copper precursor, instead of copper (II) nitrate.

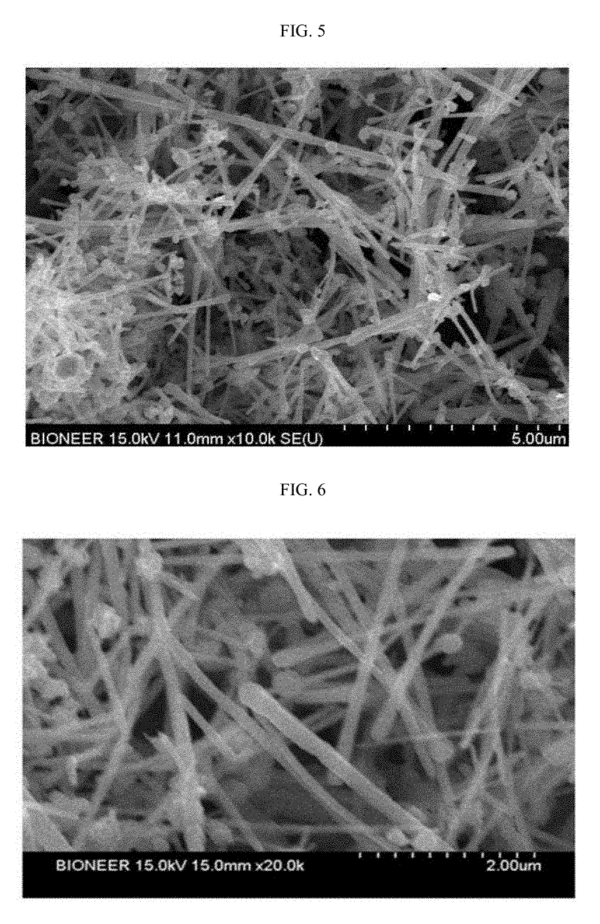

As shown in FIG. 5, formation of copper nanowires was identified with a scanning electron microscope (SEM).

### Example 4

### Synthesis of Copper Nanowires by NaOH Reuse (Use of Copper (II) Nitrate as Copper Precursor)

The ingredients that account for the greatest portions of the cost for synthesizing silver-coated copper nanowires with a core-shell structure are a silver precursor and NaOH. In the present invention, 15M (1,200 g) of NaOH is added to the copper nanowires for synthesis of copper nanowires. In this regard, NaOH is reused for process improvement. After the copper nanowires were synthesized as in Example 1, the copper nanowires were separated from the solution, and the copper (II) nitrate precursor and the reducing agent were added again to the resulting solution to synthesize copper nanowires. At this time, the copper precursor and the reducing agent were added at a controlled equivalence ratio so as not to allow the reducing agent to be left in the solution. As a result, although only the reducing agent and the copper precursor were added to the solution that had already been reacted, copper nanowires could be synthesized by reusing the same once and twice.

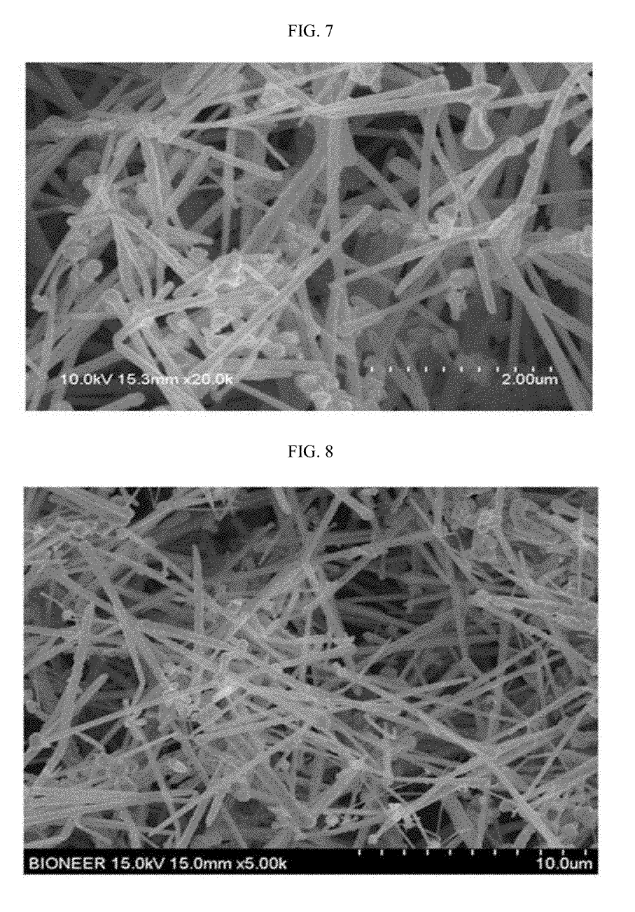

FIG. 6 shows a case where copper nanowires are synthesized by reusing a NaOH solution once, and FIG. 7 is a scanning electron microscopy (SEM) image obtained when copper nanowires are synthesized by reusing NaOH twice. These images showed that copper nanowires were successfully synthesized by injecting only a copper precursor and a reducing agent into the solution left after synthesis of copper nanowires. This showed that the NaOH solution could be used repeatedly only when the copper precursor and the reducing agent are supplied at a controlled equivalence ratio. As shown in this example, the cost of synthesizing silver-coated copper nanowires with a core-shell structure can be reduced by reusing NaOH several times.

### Example 5

### Synthesis of Copper Nanowires by NaOH Reuse (Use of Copper Hydroxide as Copper Precursor)

In the same manner as in Example 3, after copper nanowires were synthesized, copper nanowires were separated from the solution, and a copper hydroxide precursor and a reducing agent were added to the remaining solution to synthesize copper nanowires. At this time, the copper precursor and the reducing agent were added at a controlled equivalence ratio so as not to allow the reducing agent to be left in the solution. As a result, although only the reducing agent and the copper precursor were added to the solution that had already been reacted, copper nanowires could be synthesized by reusing the same once and twice.

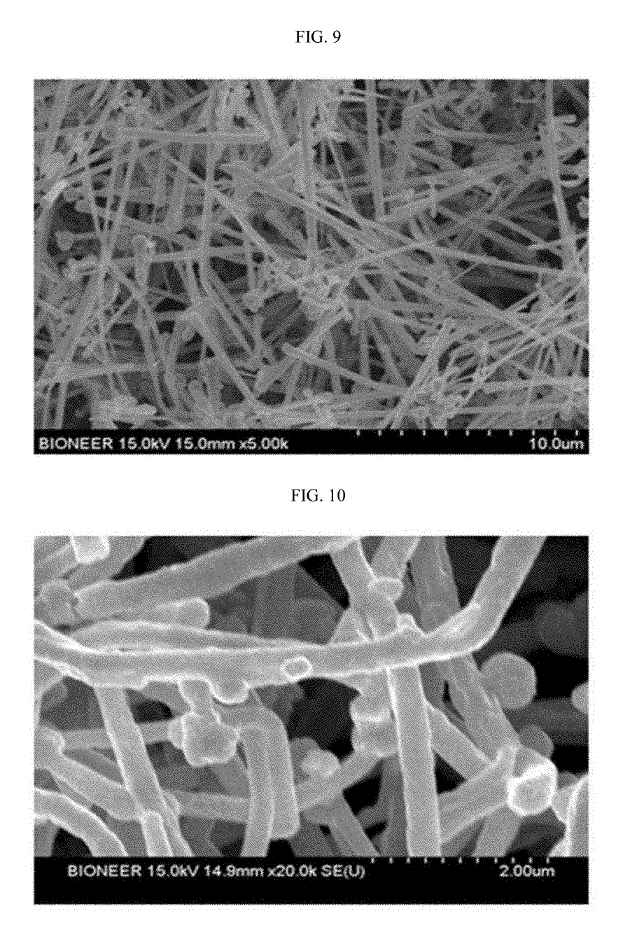

FIG. 8 shows a case where copper nanowires are synthesized by reusing a NaOH solution once, and FIG. 9 is a scanning electron microscopy (SEM) image obtained when copper nanowires are synthesized by reusing NaOH twice. These images showed that copper nanowires were successfully synthesized by injecting only a copper precursor and a reducing agent into the solution left after synthesis of copper nanowires. This showed that the NaOH solution could be used repeatedly only when the copper precursor and the reducing agent are supplied at a controlled equivalence ratio. As shown in this example, the cost of synthesizing silver-coated copper nanowires with a core-shell structure can be reduced by reusing NaOH several times.

### Example 6

### Production of Silver-Coated Copper Nanowires with a Core-Shell Structure in Reaction Solution with pH 10

100 ml of water (ultrapure water) and 1.0 g of the copper nanowires prepared in Example 1 were added to a 500 ml erlenmeyer flask and dispersed by stirring using an ultrasonic cleaner (Youngjin corporation bath sonicator (SK7210HP)) at 900 rpm for 3 hours. 0.0094M ammonium hydroxide ((NH₄)₂SO₄, Samchun Pure Chemical Co., Ltd.) and 0.0376M ammonia water (NH₄OH) were added to remove the oxide film of the copper nanowires and the mixture was stirred at 800 rpm for 3 minutes. At this time, as the oxide film was removed, the color of the solution turned blue. 0.028M of sodium potassium tartarate (C₄H₄KNaO₆.4H₂O, manufactured by Samseon Pure Chemical Industries, Co., Ltd.) as a reducing agent was added and the pH was adjusted to 10 by using potassium hydroxide (KOH, Samseon Pure Chemical Industries, Co., Ltd.) and the mixture was stirred at 800 rpm for 3 minutes.

In order to form a silver coating on copper nanowires from which the oxide film has been removed, water (ultrapure water) was mixed with nitric acid (AgNO₃, Juntech) to prepare a 0.18M silver nitrate solution, 1.5 ml of ammonia water (NH₄OH, Samchun Pure Chemical Co., Ltd.) was added to obtain a clear solution, and the resulting solution was stirred for one minute to prepare a silver-ammonia complex solution. At this time, Cu and Ag were added at a ratio of 55:45. The silver coating solution was added at a rate of 1 ml per minute, while stirring the copper nanowire solution, from which the oxide film had been removed, at a stirring rate of 800 rpm. Although the entire amount of silver coating solution was injected within about 44 minutes, the silver coating solution was reacted for one hour to achieve a sufficient coating time. After completion of the reaction, the resulting solution was washed with 2 L of water (ultrapure water) using a filter paper and dried at room temperature for 24 hours to obtain silver-coated copper nanowires.

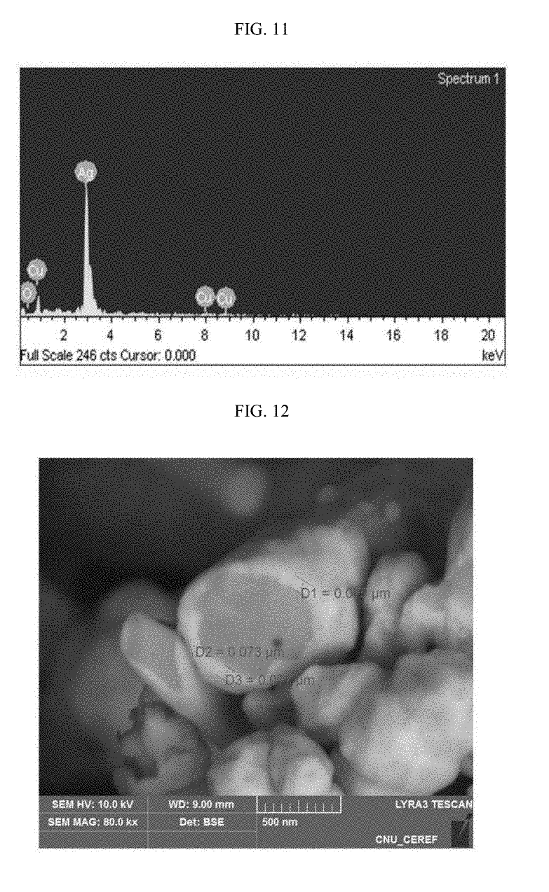

As shown in FIG. 10, formation of the silver coating on the surface of copper nanowires was identified with a scanning electron microscope (SEM). Results of scanning electron microscopy-energy dispersive spectroscopy (SEM-EDS) conducted on silver-coated copper nanowires (FIG. 11) showed that silver was coated at about 88%. At this time, the sheet resistance measured was 4.2×10⁻² Ω/sq. As a result, it can be seen that, when the pH of the reaction solution was adjusted to 10 during silver coating, the silver coating was densely formed and sheet resistance was decreased by one order, as compared to Example 3.

In addition, the thickness of silver coating on the silver-coated copper nanowires with a core-shell structure was measured. As a result, as can be seen from FIG. 12, copper wires were present in an inner part and the outer part of copper wires was coated to a thickness of about 75 nm with silver.

### Comparative Example 1

### Production of Silver-Coated Copper Nanowires with Core-Shell Structure in Reaction Solution with pH 6

Silver-coated copper nanowires with a core-shell structure were produced in the same manner as in Example 6, except that the pH of the reaction solution was adjusted to 6 using hydrochloric acid (HCl, Samchun Pure Chemical Co., Ltd.) before forming a silver coating on copper nanowires.

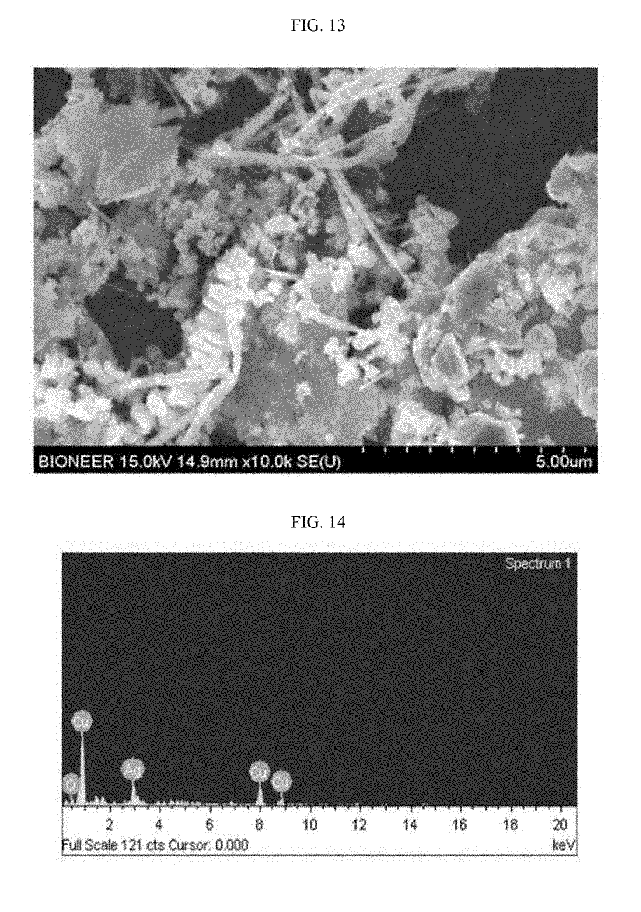

As shown in FIG. 13, formation of the silver coating on the surface of copper nanowires was identified with a scanning electron microscope (SEM). Results of scanning electron microscopy-energy dispersive spectroscopy (SEM-EDS) conducted on silver-coated copper nanowires (FIG. 14) showed that silver was coated at about 37%, which was decreased by about 50%, as compared to Example 5. At this time, the sheet resistance measured was 3.3×10⁻² Ω/sq. As a result, it can be seen that, when the pH of the reaction solution was adjusted to 6 during silver coating, the silver coating proportion was decreased and sheet resistance was increased by 10⁴-times or more.

### Comparative Example 2

### Production of Silver-Coated Copper Nanowires with Core-Shell Structure in Reaction Solution with pH 12

Silver-coated copper nanowires with a core-shell structure were produced in the same manner as in Example 6, except that the pH of the reaction solution was adjusted to 12 using potassium hydroxide before forming a silver coating on copper nanowires.

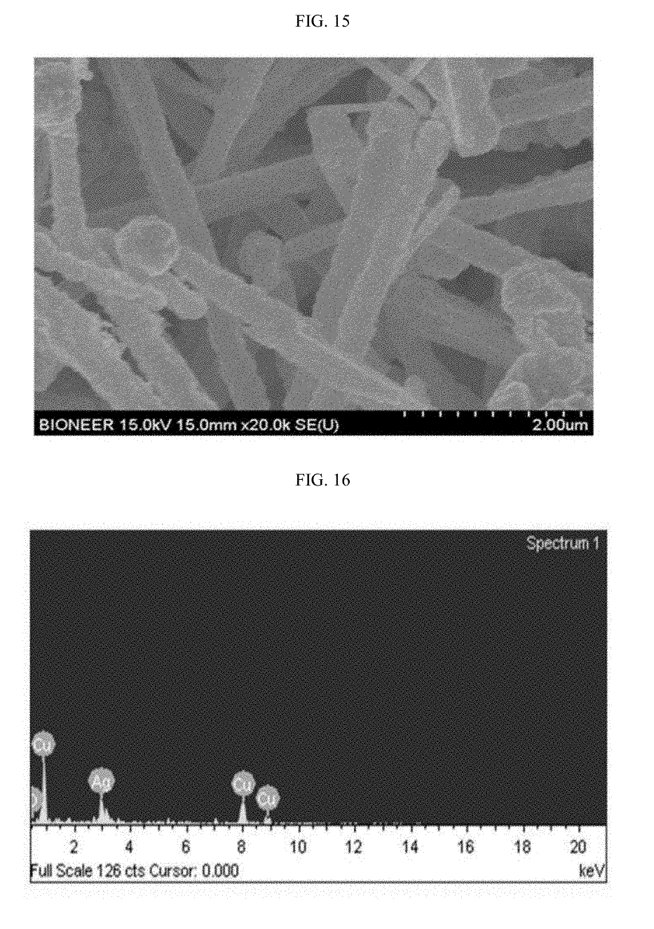

As shown in FIG. 15, formation of the silver coating on the surface of copper nanowires was identified with a scanning electron microscope (SEM). Results of scanning electron microscopy-energy dispersive spectroscopy (SEM-EDS) conducted on silver-coated copper nanowires (FIG. 16) showed that silver was coated at about 31%, which was decreased by about 57%, as compared to Example 6. At this time, the sheet resistance measured was 1.1×10⁻¹ Ω/sq. As a result, it can be seen that the yield was decreased by about 10%, as compared to Example 6 wherein silver coating was conducted with the pH adjusted to 10.

### Example 7

### Production of Silver-Coated Copper Nanowires with Core-Shell Structure with 0.14M Silver Nitrate

In the present Example, the experiment to reduce the amount of silver coated on the copper nanowires was conducted to improve economic efficiency. Silver-coated copper nanowires with a core-shell structure were produced in the same manner as in Example 6, except that 0.14M silver nitrate was used to prepare a silver-ammonia complex solution regarding the method of Example 5. The concentration of silver nitrate fed in Example 6 was 0.18M, which indicates that silver was added at 45% with respect to the weight of copper and silver nitrate added in the present Example 7 was 0.14M, which indicates silver was added at 40% with respect to the weight of copper. That is, silver-coated copper nanowires with a core-shell structure were produced while decreasing the silver content by about 5%.

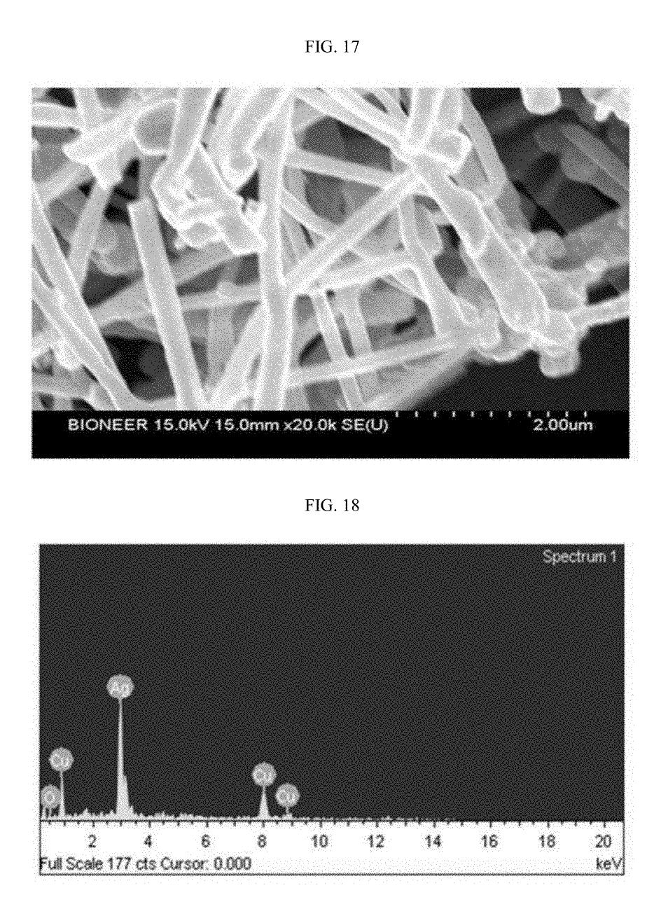

As shown in FIG. 17, formation of the silver coating on the surface of copper nanowires was identified with a scanning electron microscope (SEM). Results of scanning electron microscopy-energy dispersive spectroscopy (SEM-EDS) conducted on silver-coated copper nanowires (FIG. 18) showed that silver was coated at about 70%. At this time, the sheet resistance measured was 5.3×10⁻² Ω/sq. As a result, it can be seen that the sheet resistance of the silver-coated copper nanowires with a core-shell structure was similar to that of the silver-coated copper nanowires produced in Example 7.

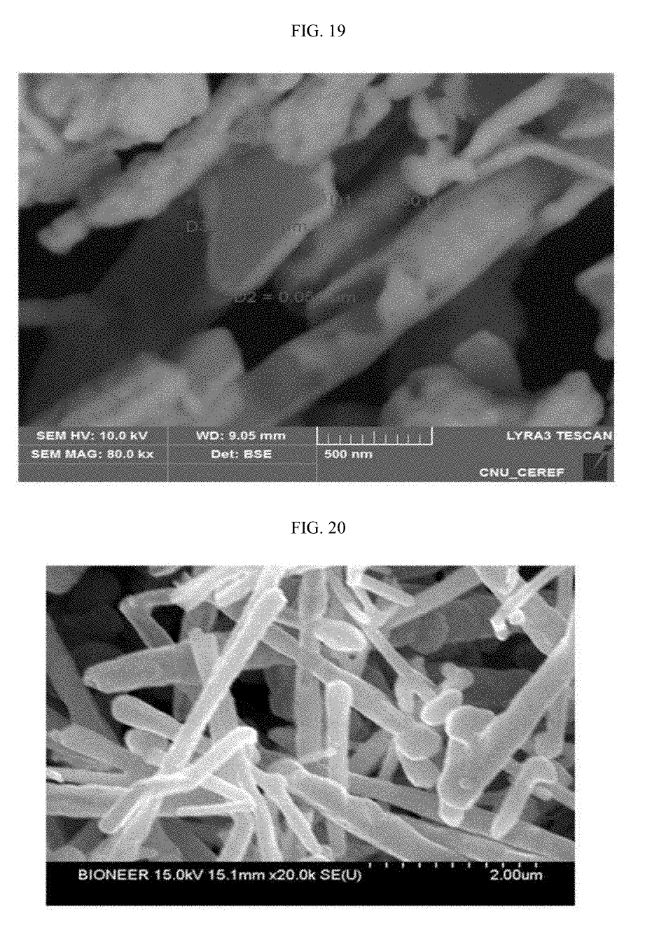

In addition, the thickness of silver coated on silver-coated copper nanowires with a core-shell structure was measured. As a result, as can be seen from FIG. 19, copper wires were present in an inner part and the outer part of the copper wires was coated with silver to a thickness of about 66 nm. As the amount of silver nitrate fed during silver coating was decreased from 0.18M to 0.14M, as compared to Example 5, the thickness of the silver coating was also decreased from about 75 nm to about 66 nm.

### Example 8

### Production of Silver-Coated Copper Nanowires with Core-Shell Structure with 0.14M Silver Coating Solution

Silver-coated copper nanowires with a core-shell structure were produced in the same manner as in Example 6, except that 0.11M silver nitrate was used to prepare a silver-ammonia complex solution regarding the method of Example 6. The concentration of silver nitrate fed in Example 8 was 0.11M, which indicates that silver was added in an amount of 35% with respect to the weight of copper. That is, silver-coated copper nanowires with a core-shell structure were produced while decreasing the silver content by about 10%, as compared to Example 5.

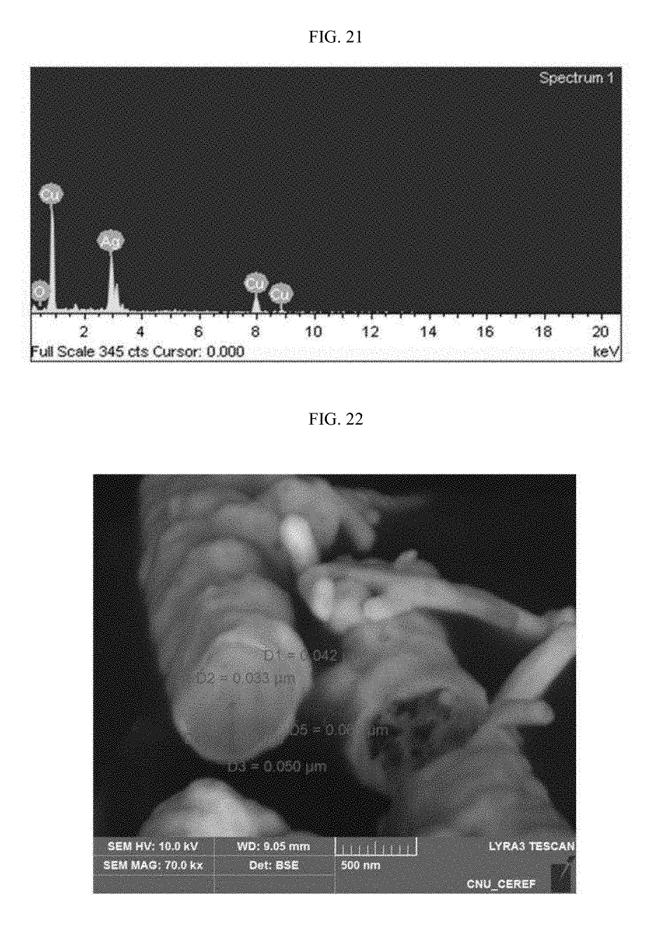

As shown in FIG. 20, formation of the silver coating on the surface of copper nanowires was identified with a scanning electron microscope (SEM). Results of scanning electron microscopy-energy dispersive spectroscopy (SEM-EDS) conducted on silver-coated copper nanowires (FIG. 21) showed that silver was coated at about 57%. At this time, the sheet resistance measured was 3.7×10⁻² Ω/sq. As a result, it can be seen that the sheet resistance of the silver-coated copper nanowires with a core-shell structure was similar to that of the silver-coated copper nanowires produced in Example 6.

In addition, the thickness of silver coated on silver-coated copper nanowires with a core-shell structure was measured. As a result, as can be seen from FIG. 22, copper wires were present in an inner part and the outer part of the copper wires was coated with silver at a thickness of about 48 nm. As the amount of silver nitrate fed during silver coating was decreased from 0.18M to 0.14M, as compared to Example 6, the thickness of silver coating was also decreased from about 75 nm to about 48 nm.

### Example 9

### Production of Silver-Coated Copper Nanowires with Core-Shell Structure with 0.09M Silver Coating Solution

Silver-coated copper nanowires with a core-shell structure were produced in the same manner as in Example 6, except that 0.09M silver nitrate was used to prepare a silver-ammonia complex solution regarding the method of Example 5. The concentration of silver nitrate fed in Example 9 was 0.09M, which indicates that silver was added in an amount of 30% with respect to the weight of copper. That is, silver-coated copper nanowires with a core-shell structure were produced while decreasing the silver content by about 15%, as compared to Example 5.

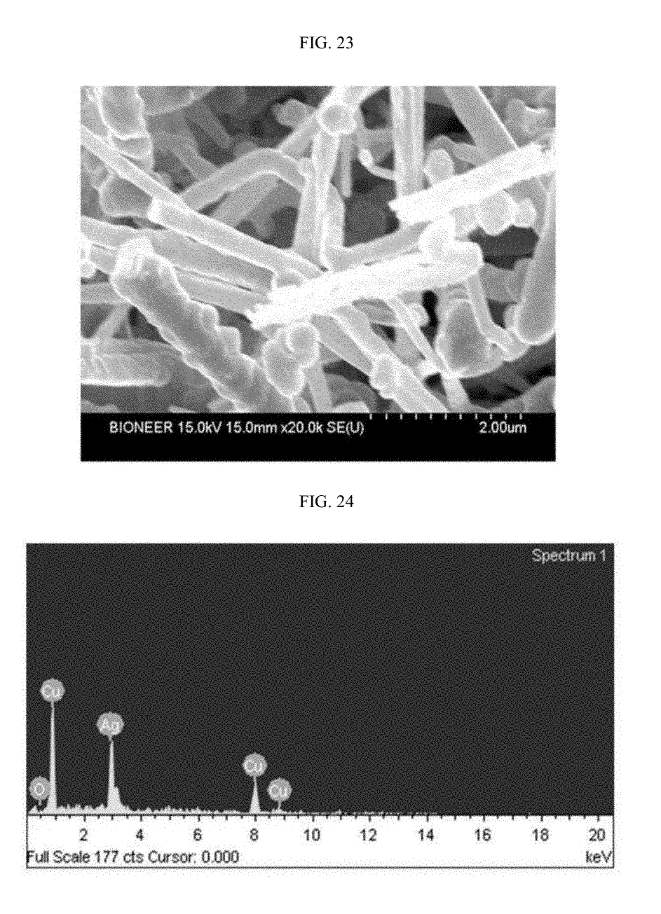

As can be seen from FIG. 23, formation of the silver coating on the surface of copper nanowires was identified with a scanning electron microscope (SEM). Results of scanning electron microscopy-energy dispersive spectroscopy (SEM-EDS) conducted on silver-coated copper nanowires (FIG. 24) showed that silver was coated at about 43%. At this time, the sheet resistance measured was 4.4×10⁻² Ω/sq. As a result, it can be seen that the sheet resistance of the silver-coated copper nanowires with a core-shell structure was similar to that of the silver-coated copper nanowires produced in Example 6.

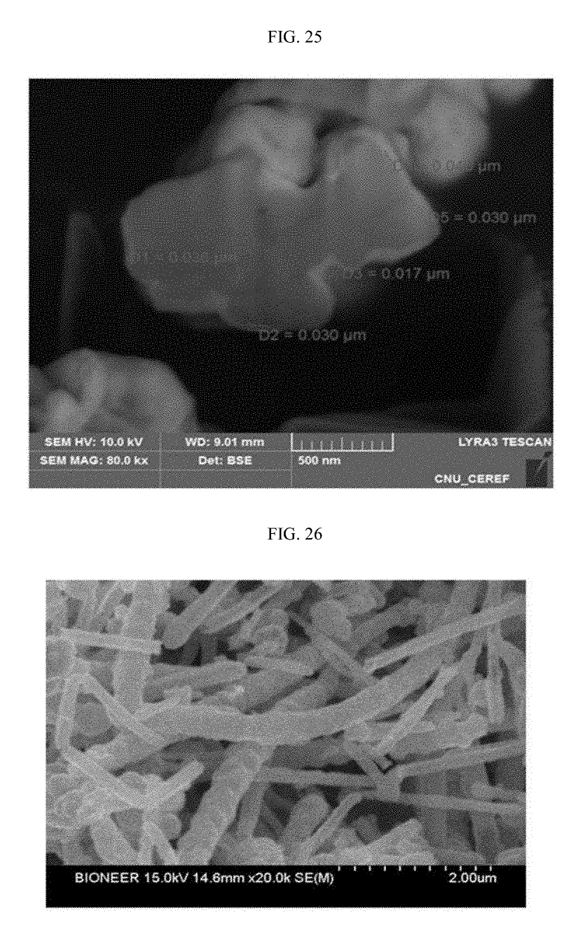

In addition, the thickness of silver coated on silver-coated copper nanowires with a core-shell structure was measured. As a result, as can be seen from FIG. 25, copper wires were present in an inner part and the outer part of the copper wires was coated with silver to a thickness of about 30.6 nm. As the amount of silver nitrate fed during silver coating was decreased from 0.18M to 0.09M, as compared to Example 6, the thickness of silver coating was also decreased from about 75 nm to about 30.6 nm.

### Example 10

### Production of Silver-Coated Copper Nanowires with Core-Shell Structure Using Tartaric Acid as Reducing Agent

Silver-coated copper nanowires with a core-shell structure were produced in the same manner as in Example 6, except that tartaric acid (C₄O₆H₆, Samchun Pure Chemical Co., Ltd.) was used, as a reducing agent, instead of sodium potassium tartrate (C₄H₄KNaO₆.4H₂O, Samchun Pure Chemical Co., Ltd.) regarding the method of Example 6.

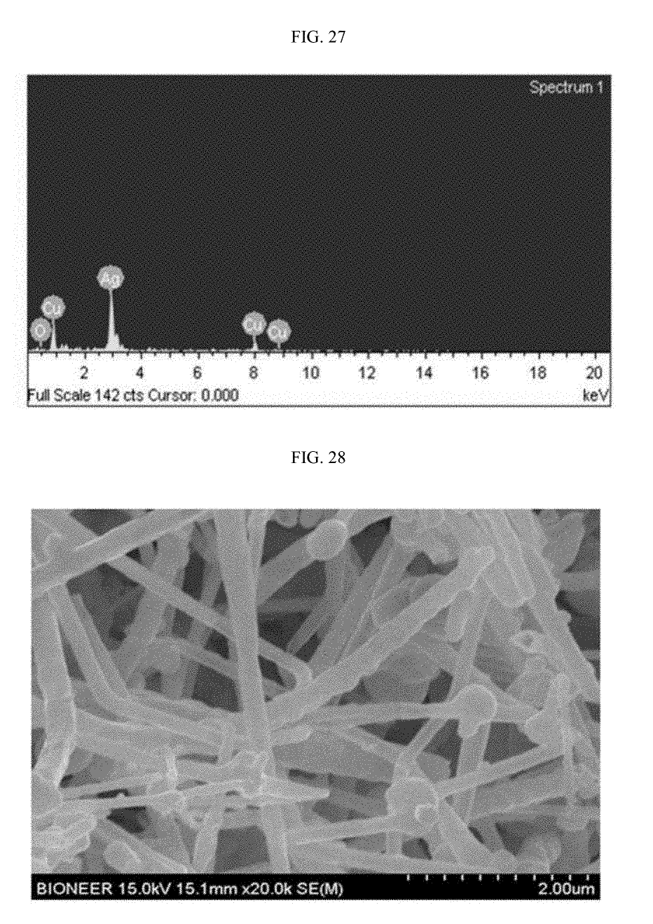

As can be seen from FIG. 26, formation of the silver coating on the surface of copper nanowires was identified with a scanning electron microscope (SEM). Results of scanning electron microscopy-energy dispersive spectroscopy (SEM-EDS) conducted on silver-coated copper nanowires (FIG. 27) showed that silver was coated at about 72%. At this time, the sheet resistance measured was 1.3×10⁻¹ Ω/sq.

### Example 11

### Production of Silver-Coated Copper Nanowires with Core-Shell Structure Using 0.14M Silver Nitrate and Tartaric Acid as Reducing Agent

Silver-coated copper nanowires with a core-shell structure were produced in the same manner as in Example 7, except that tartaric acid (C₄O₆H₆, Samchun Pure Chemical Co., Ltd.) was used, as a reducing agent, instead of sodium potassium tartrate (C₄H₄KNaO₆.4H₂O, Samchun Pure Chemical Co., Ltd.) regarding the method of Example 7.

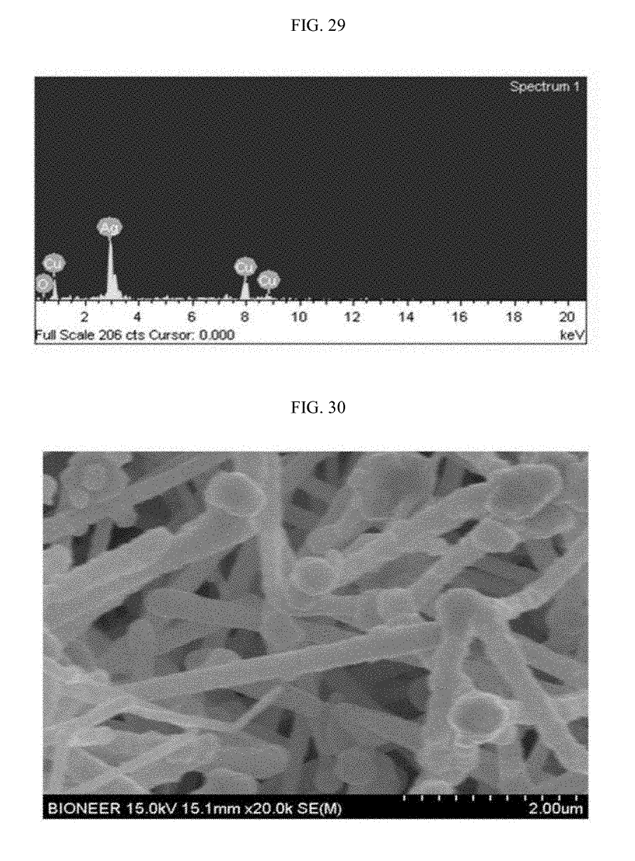

As shown in FIG. 28, formation of silver coating on the surface of copper nanowires was identified with a scanning electron microscope (SEM). Results of scanning electron microscopy-energy dispersive spectroscopy (SEM-EDS) conducted on silver-coated copper nanowires (FIG. 29) showed that silver was coated at about 60%. At this time, the sheet resistance measured was 1.5×10⁻¹ Ω/sq.

### Example 12

### Production of Silver-Coated Copper Nanowires with Core-Shell Structure Using 0.11M Silver Nitrate and Tartaric Acid as Reducing Agent

Silver-coated copper nanowires with a core-shell structure were produced in the same manner as in Example 8, except that tartaric acid (C₄O₆H₆, Samchun Pure Chemical Co., Ltd.) was used, as a reducing agent, instead of sodium potassium tartrate (C₄H₄KNaO₆.4H₂O, Samchun Pure Chemical Co., Ltd.) regarding the method of Example 8.

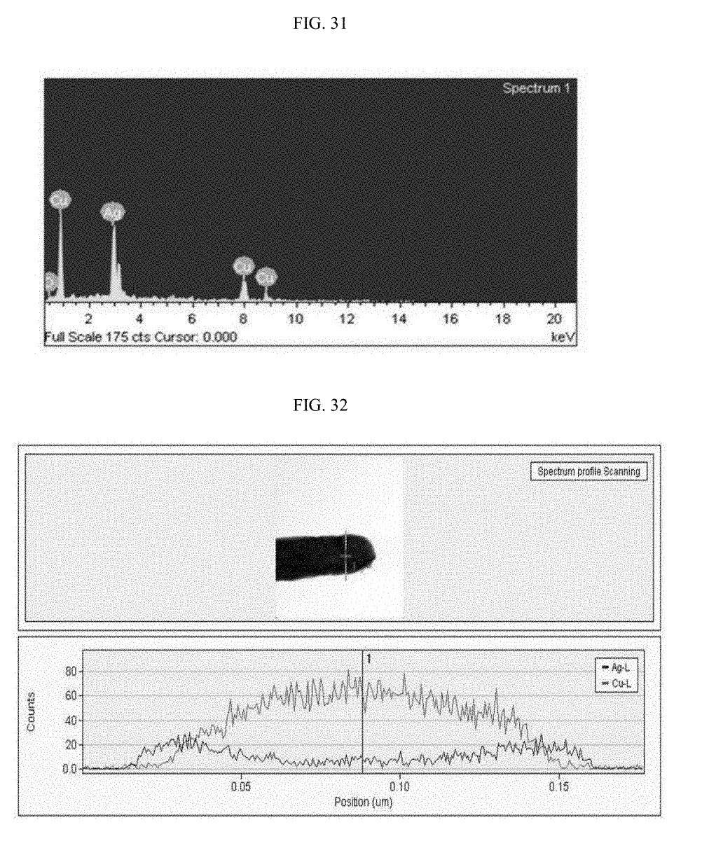

As shown in FIG. 30, formation of the silver coating on the surface of copper nanowires was identified with a scanning electron microscope (SEM). Results of scanning electron microscopy-energy dispersive spectroscopy (SEM-EDS) conducted on silver-coated copper nanowires (FIG. 31) showed that silver was coated at about 51%. At this time, the sheet resistance measured was 2.5×10⁻¹ Ω/sq.

### Experimental Example 1

### Oxidation Test of Silver-Coated Copper Nanowires with Core-Shell Structure

In order to evaluate oxidation properties of silver-coated copper nanowires with a core-shell structure, copper nanowires produced by the method of Example 1, and silver-coated copper nanowires with a core-shell structure produced by the methods of Examples 7, 8 and 9 were each laminated on GF filters and then heated at 200° C. for one hour.

Table 1 shows sheet resistance of copper nanowires produced in Example 1 and silver-coated copper nanowires with a core-shell structure produced in Examples 7, 8 and 9 before and after heating. As shown in Table 1, the sheet resistance of copper nanowires before heating was 2.6×10⁻² Ω/sq, whereas the sheet resistance thereof after heating was increased to 8.7×10⁶ Ω/sq. This means that the copper nanowires were oxidized when allowed to stand for a long time or heated. On the other hand, when silver-coated copper nanowires with a core-shell structure produced in the methods of Examples 7 to 9 were oxidized under the same conditions, the silver-coated copper nanowires of all Examples had sheet resistance of 3 to 4×10⁻² Ω/sq, which was similar to sheet resistance before heating. This means that the silver-coated copper nanowires with a core-shell structure produced by the present invention were not oxidized.

TABLE 1

| | Before heating | After heating at 200° C. |
|---|---|---|
| Copper nanowire | 2.6 × 10⁻² Ω/□ | 8.7 × 10⁶ Ω/□ |
| Example 6 | 5.3 × 10⁻² Ω/□ | 3.4 × 10⁻² Ω/□ |
| Example 7 | 3.7 × 10⁻² Ω/□ | 3.2 × 10⁻² Ω/□ |
| Example 8 | 4.4 × 10⁻² Ω/□ | 3.7 × 10⁻² Ω/□ |

### Experimental Example 2

### Analysis Results of Silver and Copper Contents of Silver-Coated Copper Nanowires with Core-Shell Structure Produced in Accordance with Examples

In order to identify whether or not silver-coated copper nanowires with a core-shell structure produced in accordance with Examples 7 to 9 were coated with silver, silver and copper ingredients of silver-coated copper nanowires produced with a high-frequency inductively coupled plasma atomic emission spectrometer (ICP-AES) and an energy dispersive spectroscope mounted on a transmission electron microscope were analyzed.

First, in order to assay contents of silver and copper, silver-coated copper nanowires with a core-shell structure produced by the methods of Examples 7 to 9 were analyzed using a high-frequency inductively coupled plasma torch (ICP-AES).

Table 2 shows results of analysis of silver-coated copper nanowires with a core-shell structure produced by the methods of Examples 7 to 9 using inductively coupled plasma atomic emission spectroscopy (ICP-AES). Analysis results showed that, as shown in Table 2, as the amount of silver nitrate gradually decreases in an order of 0.14M, 0.11M and 0.09M during silver coating, the content of silver coated on the copper nanowires gradually decreases in an order of 54.7%, 47%, and 40.2%.

TABLE 2

| Analysis sample | Ag(wt %) | Cu(wt %) |
|---|---|---|
| Example 7 | 54.7 | 43.3 |
| Example 8 | 47.0 | 51.7 |
| Example 9 | 40.2 | 58.1 |

In addition, in order to identify whether or not silver was formed in the form of a core-shell structure on copper nanowires, silver-coated copper nanowires with a core-shell structure produced in Example 7 were subjected to spectrum profile scanning with an energy dispersive spectroscope mounted on a transmission electron microscope. As a result, as can be seen from FIG. 30, silver-coated copper nanowires having a core-shell structure have a core-shell structure in which copper was present in an inner part and the outer part of copper nanowires was coated with silver were formed.

### INDUSTRIAL APPLICABILITY

The method of preparing silver-coated copper nanowires having a core-shell structure according to the present invention can avoid deterioration in electrical conductivity by preventing oxidation even in the air or at high temperatures and thus provide copper nanowires having higher economic efficiency, as compared to pure silver nanoparticles or nanowires.

Although specific configurations of the present invention has been described in detail, those skilled in the art will appreciate that this description is provided as preferred embodiments for illustrative purposes and should not be construed as limiting the scope of the present invention. Therefore, the substantial scope of the present invention is defined by the accompanying claims and equivalents thereto.

1. A method of preparing silver-coated copper nanowires having a core-shell structure comprising:
(a) stirring an aqueous solution containing (1) an alkali, (2) a copper compound and (3) a capping agent in water;
(b) producing copper nanowires by adding a reducing agent to the aqueous solution to reduce copper ions;
(c) washing and drying produced copper nanowires;
(d) removing an oxide film from the copper nanowires produced in step (c);
(e) adding a reducing agent to the solution of step (d), adjusting pH and then forming a silver coating while adding a silver nitrate-ammonia complex solution dropwise; and
(f) washing and drying silver-coated copper nanowires prepared in step (e).

2. The method of preparing silver-coated copper nanowires having a core-shell structure of claim 1, further comprising (c′) re-synthesizing copper nanowires by adding a copper precursor and a reducing agent to solution separated from the copper nanowires, after step (c).

3. The method of preparing silver-coated copper nanowires having a core-shell structure of claim 2, wherein copper nanowires is synthesized by repeating the step (c′) two or more times.

4. The method of preparing silver-coated copper nanowires having a core-shell structure of claim 1, wherein a mixed solution of ammonia water and ammonium sulfate is used as a solution for removing an oxide film in the step (d).

5. The method of preparing silver-coated copper nanowires having a core-shell structure of claim 4, wherein concentration of a mixed solution of ammonia water and ammonium sulfate in the step (d) is 0.001 to 0.3M.

6. The method of preparing silver-coated copper nanowires having a core-shell structure of claim 4, wherein the step (d) is performed for 1 to 60 minutes.

7. The method of preparing silver-coated copper nanowires having a core-shell structure of claim 1, wherein in the step (e), the reducing agent is added to the copper nanowire solution from which the oxide film is removed in the step (d), the pH is adjusted, and the silver nitrate-ammonia complex solution is injected at 0.5 to 500 ml per minute while stirring at 50 to 1600 rpm.

8. The method of preparing silver-coated copper nanowires having a core-shell structure of claim 1, wherein the reducing agent of the step (e) is selected from the group consisting of oxalic acid, malonic acid, succinic acid, glutaric acid, adipic acid, pimelic acid, suberic acid, azelaic acid, sebacic acid, brassylic acid, dodecanoic acid, thapsic acid, maleic acid, fumaric acid, gluconic acid, traumatic acid, muconic acid, glutinic acid, citraconic acid, mesaconic acid, aspartic acid, glutamic acid, diaminopimelic acid, tartronic acid, arabinaric acid, saccharic acid, mesoxalic acid, oxaloacetic acid, acetonedicarboxylic acid, phthalic acid, isophthalic acid, terephthalic acid, diphenic acid, tartaric acid, sodium potassium tartrate, ascorbic acid, hydroquinone, glucose and hydrazine.

9. The method of preparing silver-coated copper nanowires having a core-shell structure of claim 8, wherein concentration of the reducing agent is 0.001M to 3M.

10. The method of preparing silver-coated copper nanowires having a core-shell structure of claim 7, wherein pH of the copper nanowire solution is 8 to 11.

11. The method of preparing silver-coated copper nanowires having a core-shell structure of claim 7, wherein the silver nitrate-ammonia complex solution is prepared by mixing silver nitrate solution and ammonia water.

12. The method of preparing silver-coated copper nanowires having a core-shell structure of claim 11, wherein concentration of silver nitrate in the silver nitrate-ammonia complex solution is 0.001 to 1M.

13. The method of preparing silver-coated copper nanowires having a core-shell structure of claim 7, wherein concentration of ammonia water in the silver nitrate-ammonia complex solution is 0.01-0.3 M.

14. The method of preparing silver-coated copper nanowires having a core-shell structure of claim 1, wherein the (1) alkali of the step (a) is NaOH, KOH or Ca(OH)₂.

15. The method of preparing silver-coated copper nanowires having a core-shell structure of claim 1, wherein concentration of the (1) alkali is 2.5 to 25M.

16. The method of preparing silver-coated copper nanowires having a core-shell structure of claim 1, wherein the (2) copper compound of the step (a) is copper hydroxide, copper nitrate, copper sulfate, copper sulfite, copper acetate, copper chloride, copper bromide, copper iodide, copper phosphate or copper carbonate.

17. The method of preparing silver-coated copper nanowires having a core-shell structure of claim 1, wherein concentration of the copper compound of the step (a) is 0.004 to 0.5M based on copper ion.

18. The method of preparing silver-coated copper nanowires having a core-shell structure of claim 1, wherein the (3) capping agent is piperazine (C₄H₁₀N₂) or hexamethylenediamine (C₆H₁₆N₂).

19. The method of preparing silver-coated copper nanowires having a core-shell structure of claim 18, wherein concentration of the capping agent is 0.008 to 2.0 M.

20. The method of preparing silver-coated copper nanowires having a core-shell structure of claim 1, wherein the reducing agent of the step (b) is hydrazine, ascorbic acid, L(+)-ascorbic acid, isoascorbic acid, ascorbic acid derivative, oxalic acid, formic acid, phosphite, phosphoric acid, sulfite or sodium borohydride.

21. The method of preparing silver-coated copper nanowires having a core-shell structure of claim 1, wherein concentration of the reducing agent of the step (b) is 0.01 to 1.0M.

22. The method of preparing silver-coated copper nanowires having a core-shell structure of claim 1, wherein the reducing agent of the step (b) is added at a rate of 0.1 to 500 ml/min.

23. The method of preparing silver-coated copper nanowires having a core-shell structure of claim 1, wherein the step (b) is performed at a temperature of 0 to 100° C.

24. The method of preparing silver-coated copper nanowires having a core-shell structure according to claim 1, wherein the silver-coated copper nanowires are prepared by batch reaction, plug flow reaction or continuous stirring tank type reaction process.
